(19) United States
(12) Patent Application Publication
(10) Pub. No.: US 2019/0191812 A1
(43) Pub. Date: Jun. 27, 2019

(54) HAT WITH FORCED AIR COOLING

(71) Applicants: Mohamed Salem, Fresno, CA (US); Mike Sullivan, Scottsdale, AZ (US)

(72) Inventors: Mohamed Salem, Fresno, CA (US); Mike Sullivan, Scottsdale, AZ (US)

(21) Appl. No.: 15/852,781

(22) Filed: Dec. 22, 2017

(51) Int. Cl. A42B 3/28; H02S 40/38

(52) U.S. Cl. CPC A42B 3/286; H02S 99/00; H02S 40/38; A42B 3/283

(57) ABSTRACT

A hat capable of forced air cooling comprises a shell and a liner between which an air passage is formed. A fan forces air through the air passage, the air having been cooled by a phase change material carried on the hat. The liner can have grooves that channel the cooled air above and around the top of the person's head to ventilation vents at the front of the hat. The hat can have a solar cell for charging a battery and a temperature controller that manages operation of the fan.

### FIELD

This disclosure relates generally to a head covering and, more particularly, a head covering with forced air cooling.

### BACKGROUND

Hats with fans have been used to help cool people in hot climates. Such hats can benefit construction workers who often work outdoors. Construction work often requires long hours at a job site, so a high capacity battery could be used to allow cooling for an extended period of time, or multiple replacement batteries could be used throughout the day. However, high capacity batteries can be heavy, and replacement batteries can be cumbersome and inconvenient. Another issue is that cooling effectiveness is greatly reduced when ambient air temperature is extremely high. Although blowing air over the skin can have a cooling effect due to evaporation of sweat, continuously blowing air that is much greater than body temperature can have an overall effect of making the person warmer. Accordingly, what is needed is a system that addresses power management and/or cooling effectiveness in hot climates.

### SUMMARY

Briefly and in general terms, the present invention is directed to a hat and method for cooling.

In aspects of the invention, a hat comprises a shell, a liner, a PCM container, and a fan. The shell comprises a concave interior surface. The liner is attached to the shell, the liner comprising a convex upper surface, there being an air passage formed by a gap between the convex upper surface of the liner and the concave interior surface of the shell. The PCM container contains a phase change material. The fan is arranged to draw air over portions of the PCM container to cool the air and force the cooled air into the air passage.

In aspects of the invention, a method for cooling uses a hat comprising a shell, a liner attached to the shell, a PCM container attached to the shell and containing a phase change material, and a fan attached to the shell. The method comprises activating the fan to draw air over portions of the PCM container to cool the air and force the cooled air into an air passage formed by a gap between a concave interior surface of the shell and a convex upper surface of the liner.

The features and advantages of the invention will be more readily understood from the following detailed description which should be read in conjunction with the accompanying drawings.

### BRIEF DESCRIPTION OF THE DRAWINGS

FIG. 1 is an exploded schematic view of an example hat having a shell and a liner.

FIG. 2 is an assembled schematic view of the hat.

FIG. 3 is a bottom-front perspective view of an example shell.

FIG. 4 is a top-rear perspective view of an example liner.

FIG. 5 is a top view of the liner.

FIG. 6 is a cross-section view of the liner taken along line 6-6 in FIG. 5.

FIG. 7 is a top-front perspective view of an example hat.

FIG. 8 is a schematic block diagram showing example electrical components of the hat.

### DETAILED DESCRIPTION

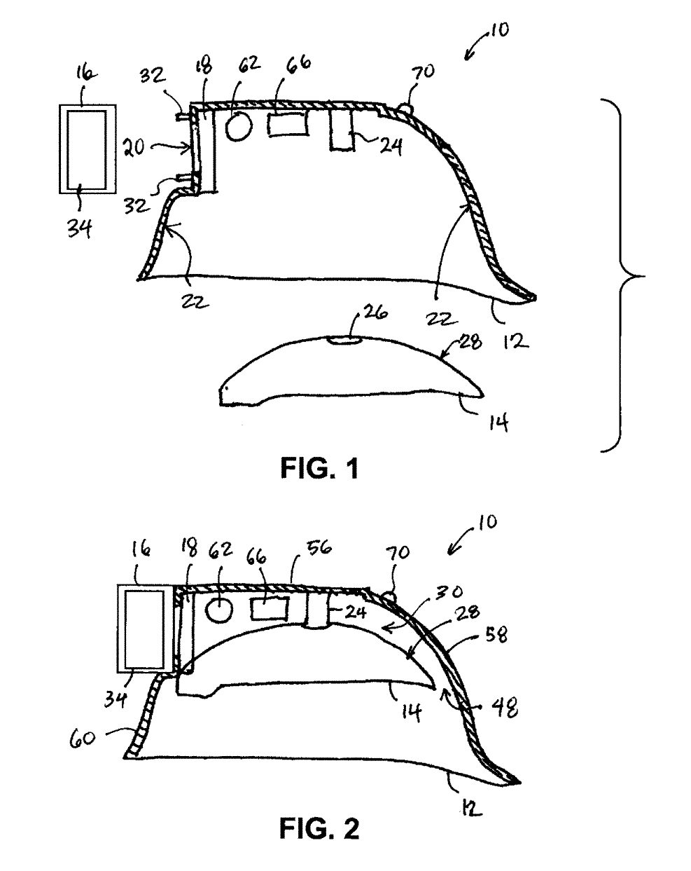

Referring now in more detail to the example drawings for purposes of illustrating aspects of the invention, wherein like reference numerals designate corresponding or like elements among the several views, there is shown in FIGS. 1 and 2 an example hat 10 that comprises shell 12, liner 14, PCM container 16, and fan 18.

Shell 12 is in the shape of a hard hat suitable for use at construction sites. For example, shell 12 can be made of acrylonitrile butadiene styrene (ABS) material, other thermoplastic polymer, or other polymer plastic. Shell 12 can have a wall thickness in the range of 2 mm to 4 mm. The shell can have other shapes.

Air intake hole 20 is formed through shell 12. Fan 18 is arranged to draw air through air intake hole 20 and into shell 12. Shell 12 comprises concave interior surface 22, and liner 14 is attached to concave interior surface 22 by securement 24. Securement 24 is configured to secure liner 14 to shell 12 and to release liner 14 from shell 12. Securement 24 can be a post on concave interior surface 22 of shell 12. The post may be threaded or ribbed. The post may engage hole 26 formed into liner 14 to secure liner 14 to shell 12. Engagement may be achieved by friction between the post and hole 26, wherein the friction is at a level that allows for release of liner 14 from shell 12. For example, a user may pull liner 14 apart from the shell 12 to overcome the frictional engagement between liner 14 and shell 12. Removal of liner 14 can allow for cleaning and maintenance of hat 10. Other types of securement can be implemented. For example, securement 24 can be a hook or latch. As a further example, securement 24 may be in the form of hook and loop tape, such as Velcro®.

Liner 14 comprises convex upper surface 28. When liner 14 is secured to shell 12, air passage 30 (FIG. 2) is formed by a gap between convex upper surface 28 of liner 14 and concave interior surface 22 of shell 12.

PCM is an acronym for phase change material. PCM container 16 contains phase change material 34. Fan 18 comprises an electric motor and fan blades attached to the motor. Fan 18 is arranged to draw air over portions of the PCM container to cool the air and force the cooled air into air passage 30. For example, fan 18 can be mounted inside shell 12 as illustrated. As a further example, fan 18 can be mounted outside of shell 12.

Phase change material 34 absorbs energy when it undergoes a phase change, such as a solid/liquid phase transition or a solid/solid phase transition. The temperature of a phase change material can rise when it absorbs heat, but when the phase change material reaches its phase change temperature (e.g., melting temperature), the phase change material continues to absorb heat while its temperature remains almost constant at the phase change temperature. PCM container 16 should contain a phase change material having a phase change temperature below normal human body temperature of 37° C. (98° F.). For example, without limitation, phase change material 34 can be paraffin wax having a phase change temperature in the range of 24° C. to 32° C. Tests performed by Applicant using this material in a hat with forced air flow showed that skin temperature of the wearer was reduced by as much as 10° C. (18° F.). Other phase change materials known in the art can be used.

PCM container 16 can effectively enlarge the ambient air temperature range at which hat 10 can provide effective cooling. As previously mentioned, using forced air at temperatures that are much greater than body temperature can have an overall effect of making the person warmer. PCM container 16 can allow a cooling effect to be achieved even in extremely hot climates by reducing the temperature of the forced air to a temperature below body temperature.

PCM container 16 is configured to be removed from shell 12 without damage to PCM container 16 and shell 12. Removability of PCM container 16 allows it to be reconditioned in a refrigeration unit, such as a freezer, without shell 12. This saves space in the refrigeration unit and allows many PCM containers to be reconditioned together.

For example, PCM container 16 can be configured to slide on and off of shell 12 by means of posts 32 (FIG. 1), as illustrated, or by means of a pocket located on or within shell 12. Post 32 may be threaded or ribbed. Each post 32 may engage holes formed in PCM container 16. Engagement may be achieved by friction between posts 32 and PCM container 16, wherein the friction is at a level that allows for release of PCM container 16 from shell 12. For example, user may pull PCM container 16 apart from the shell 12 to overcome the frictional engagement between PCM container 16 and shell 12. Other types of securement can be implemented. For example, the posts can be hooks or latches. As a further example, posts 32 may be configured to engage screws that retain between PCM container 16.

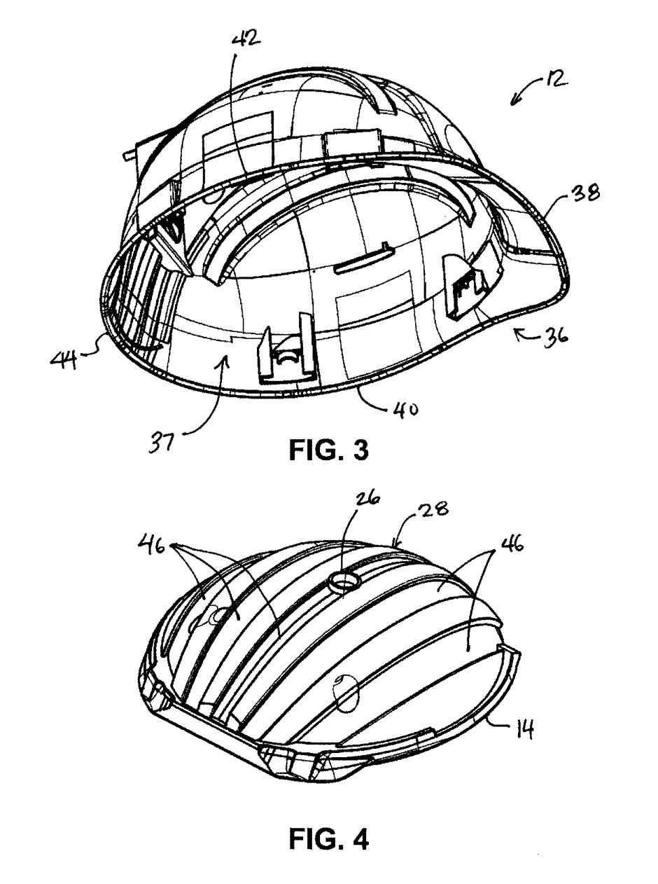

As shown in FIG. 3, shell 12 comprises outer edge 36. Outer edge 36 forms the bottom of hat 10. Outer edge 36 comprises front edge 38, left edge 40, right edge 42, and rear edge 44. From the perspective of the wearer, left edge 40 extends leftward from front edge 38. Right edge 42 extends rightward from front edge 38. Rear edge 44 is located opposite front edge 38 and extends from left edge 40 to right edge 42. Outer edge 36 defines head opening 37 sized to accept a person's head such that the person's face is disposed below front edge 38.

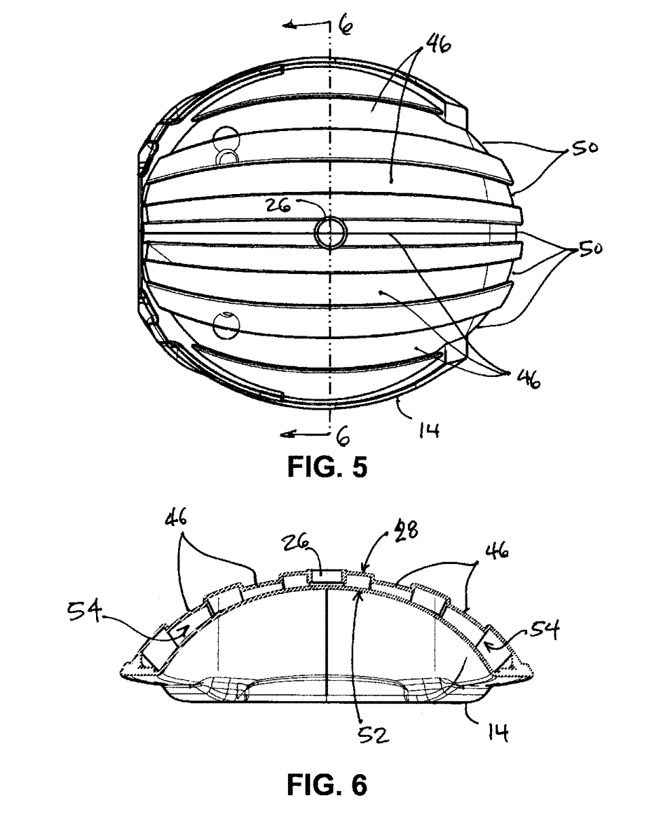

As shown in FIGS. 4 and 5, grooves 46 are formed into convex upper surface 28 of liner 14. Each grooves 46 extends linearly, as shown in FIG. 5, from rear edge 44 (FIG. 3) of shell 12 to front edge 38 of shell 12. Five grooves are illustrated, although a lesser or greater number of grooves may be implemented. For example, only a single groove could be formed in the liner.

Grooves 46 define, at least in part, air passage 30 (FIG. 2). Air passage 30 may be located exclusively in grooves 46. Alternatively, air passage 30 may be located in grooves 46 and above other areas of convex upper surface 28 of liner 14.

Grooves 46 help to direct cooled air from the rear of hat 10 to the front. Each groove 46 forms exhaust vent 48 (FIG. 2) at forward end 50 (FIG. 5) of groove 46. Exhaust vent 48 (FIG. 2) directs the cooled air toward front edge 38 (FIG. 3) of shell 12 to cool the person's face.

As shown in FIG. 6, liner 14 can be double-walled. There is convex upper surface 28 with grooves 48 and dome surface 52 below convex upper surface 28. Dome surface 52 is shaped to support the persons head comfortably. Dome surface 52 is attached to and spaced part from convex upper surface 28 so as to form liner air gap 54 between dome surface 52 and convex upper surface 28. Dome surface 52 may be attached to convex upper surface 28 by ultrasonic welding, adhesives, molding dome surface 52 and convex upper surface 28 as a unitary structure, or by other means. Liner air gap 54 may be hermetically sealed by dome surface 52 and convex upper surface 28 to prevent entry of dirt, facilitate cleaning of liner 14, and enhance thermal insulation properties.

The double-walled configuration of liner 14 may provide multiple advantages. The double-walled configuration creates distance between the top of the person's head (which contacts dome surface 52) and air passage 30 (which is located above convex upper surface 28). The distance and liner air gap 54 insulates the cooled air that travels above convex upper surface 28, which can help ensure that the air remains cool when it reaches exhaust vents 48 (FIG. 2) of at the forward ends of grooves 46. In addition, the double-walled configuration can provide the wearer with additional protection by serving as a collapsible structure that can absorb shock in case an object or construction material falls and hits shell 12. Dome surface 52 and convex upper surface 28 can be made of silicon rubber that has a thickness in the range of 2 mm to 3 mm.

Referring again to FIG. 2, shell 12 comprises apex 56 and forward-facing quadrant 58. Apex 56 is the highest part of shell 12. That is, apex 56 is higher in elevation than all other parts of shell 12. Forward-facing quadrant 58 extends from front edge 38 (FIG. 3) of shell 12 to apex 56. Forward-facing quadrant 58 is defined as the region of shell 12 bounded by two vertical planes, which are perpendicular as viewed from above shell 12 and which intersect at the center of shell 12. The two planes can be imagined as cutting shell 12 into four regions, one of which is forward-facing quadrant 58. Portions of forward-facing quadrant 58 are located directly above air passage 30. There is no through-hole formed in any portion of forward-facing quadrant 58 directly above air passage 30. A through-hole formed in forward-facing quadrant 58 may allow cooled air to escape from air passage 30. The absence of any such through-hole can increase the amount of cooled air that reaches exhaust vents 48 (FIG. 2) to cool the person's face.

Still referring to FIG. 2, shell 12 includes rear-facing quadrant 60 that extends from rear edge 44 (FIG. 3) of shell 12 to apex 56. Air intake hole 20 is formed through rear -facing quadrant 60. PCM container 16 is located at rear-facing quadrant 60. Having PCM container 16 located at the rear of shell 12 allows cooled air to be produced at the rear of shell 12 and then conveyed above the person's head before the cooled air is discharged from exhaust vents 48 (FIG. 2). Forcing the cooled air circulated over the person's head could provide the wearer with additional cooling.

In addition, having PCM container 16 located on rear-facing quadrant 60 could reduce the possibility that PCM container 16 may obstruct movement of the person's head in confined working environments. For example, when the person bends to lower his or her head to avoid a low beam, it would be advantageous to have nothing protruding from forward-facing quadrant 58 that might hit the low beam. Having PCM container 16 located on rear-facing quadrant 60 addresses this potential problem and could also allow for placement of a forward-facing lantern or insignia on forward-facing quadrant 58.

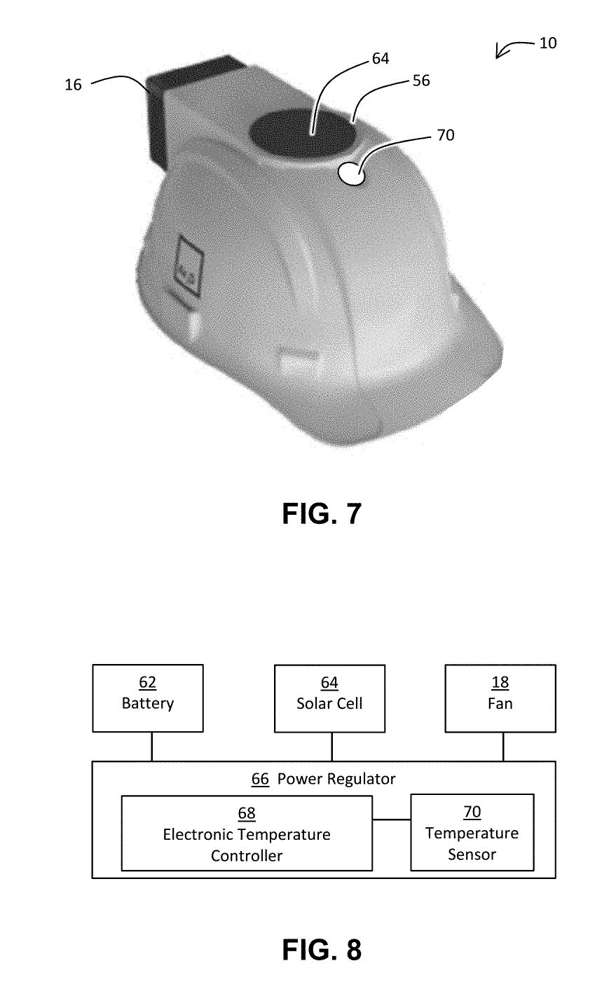

As shown in FIGS. 7 and 8, hat 10 comprises battery 62 and solar cell 64. Battery 62 is attached to shell 12. Solar cell 64 is attached to an exterior surface at apex 56 of shell 12. Battery 62 is configured to power fan 18. Solar cell 64 comprises semiconducting materials that exhibit a photovoltaic effect that converts light from the sun to electricity. Solar cell 64 is electrically connected to battery 62 and is configured to charge battery 62.

Use of solar cell 64 allows fan 18 to operate for longer periods of time with a smaller size battery. This can reduce the weight of battery 62 and thus reduce the overall weight of hat 10. Use of solar cell 64 can also reduce the need to replace a depleted battery while the person is working.

Hat 10 comprises power regulator 66 to regulate power from battery 62 to fan 18 and to regulate charging of battery 62 by solar cell 64. Power regulator 66 comprises electronic temperature controller 68 and temperature sensor 70 coupled to electronic temperature controller 68. Electronic temperature controller 68 comprises circuits configured to activate and deactivate fan 18 according to signals from temperature sensor 70. For example, electronic temperature controller 68 may include a microcontroller or microprocessor that receives signals from temperature sensor 70 and determines ambient air temperature based on the received signals. Temperature sensor 70 can be an infrared temperature sensor configured to detect infrared energy which is proportional to ambient temperature.

Electronic temperature controller 68 can be programmed to turn on and turn off fan 18 according to the ambient temperature that was determined. Additionally or alternatively, electronic temperature controller 68 can be programmed to adjust the rotation rate of fan 18 (for example, from a first non-zero rotation rate to a second non-zero rotation rate) according to the ambient temperature that was determined. Temperature controller 68 can have memory for storing temperature control parameters.

Temperature controller 68 may also take into account the phase change temperature (T) of phase change material 34. Electronic temperature controller 68 can be programmed to turn on and turn off fan 18 according to the ambient temperature and the phase change temperature (T). Additionally or alternatively, electronic temperature controller 68 can be programmed to adjust the rotation rate of fan 18 according to the ambient temperature and the phase change temperature (T).

For example, electronic temperature controller 68 may use a first threshold value stored in its memory. If ambient air temperature rises above the first threshold value, fan 18 will be turned on, and when ambient temperature falls below the first threshold value, fan 18 will be turned off. The first threshold value may be based, at least in part, on the phase change temperature (T) of phase change material 34. For instance, without limitation, the first threshold value may be equal to the sum of a number (X) and the phase change temperature (T), where X is greater than or equal to 0. This method of power management can conserve battery power by generating forced air only at times when it is needed. Electronic temperature controller 68 may use a second threshold stored in its memory. The second threshold value can be greater than the first threshold value so that when ambient air temperature rises above the second threshold value, the rate of rotation of fan 18 will be increased to allow greater cooling of the air by phase change material 34. When ambient air temperature falls below the second threshold value, the rate of rotation of fan 18 will be decreased. The availability of a slower rotation can also conserve battery power and it may also allow phase change material 34 to last longer.

While several particular forms of the invention have been illustrated and described, it will also be apparent that various modifications can be made without departing from the scope of the invention. It is also contemplated that various combinations or subcombinations of the specific features and aspects of the disclosed embodiments can be combined with or substituted for one another in order to form varying modes of the invention. Accordingly, it is not intended that the invention be limited, except as by the appended claims.

1. A hat for cooling, the hat comprising:
a shell comprising a concave interior surface;
a liner attached to the shell, the liner comprising a convex upper surface, there being an air passage formed by a gap between the convex upper surface of the liner and the concave interior surface of the shell;
a PCM container containing a phase change material; and
a fan arranged to draw air over portions of the PCM container to cool the air and force the cooled air into the air passage.

2. The hat of claim 1, wherein the liner comprises a dome surface attached to the convex upper surface.

3. The hat of claim 1, wherein the shell comprises a securement configured to secure the liner to the shell and to release the liner from the shell.

4. The hat of claim 1, wherein:
the shell comprises an outer edge, the outer edge comprises a front edge, a left edge extending leftward from the front edge, a right edge extending rightward from front edge, and a rear edge opposite the front edge and extending from the left edge to the right edge, and
the outer edge defines an head opening sized to accept the a person's head such that the person's face is disposed below the front edge.

5. The hat of claim 4, wherein a groove is formed into the convex upper surface of the liner, the groove defines, at least in part, the air passage, and wherein the groove forms an exhaust vent at a forward end of the groove, and the exhaust vent directs the cooled air toward the front edge of the shell to cool the person's face.

6. The hat of claim 4, wherein the shell comprises an apex and a rear-facing quadrant that extends from the rear edge of the shell to the apex, and wherein an air intake hole is formed through the rear-facing quadrant, and the PCM container is disposed over the air intake hole.

7. The hat of claim 4, wherein the shell comprises an apex and a forward-facing quadrant, the forward-facing quadrant extends from the front edge of the shell to the apex, and there is no through-hole formed in any portion of the forward-facing quadrant directly above the air passage.

8. The hat of claim 1, further comprising a battery and a solar cell, the solar cell attached to an exterior surface of the shell, the battery configured to power the fan, the solar cell configured to charge the battery.

9. The hat of claim 1, further comprising a power regulator, the power regulator comprising an electronic temperature controller and a temperature sensor coupled to the electronic temperature controller, the electronic temperature controller comprising circuits configured to activate and deactivate the fan according to signals from the temperature sensor.

10. The hat of claim 1, wherein the PCM container is removable from the shell without damage to the PCM container and the shell.

11. A method for cooling using a hat comprising a shell, a liner attached to the shell, a PCM container attached to the shell and containing a phase change material, and a fan attached to the shell, the method comprising:
activating the fan to draw air over portions of the PCM container to cool the air and force the cooled air into an air passage formed by a gap between a concave interior surface of the shell and a convex upper surface of the liner.

12. The method of claim 11, further comprising protecting a person's head with the hat, wherein the liner comprises a dome surface attached to the convex upper surface, and the dome surface rests on the person's head.

13. The method of claim 11, wherein before activating the fan, the method comprises detaching the liner from the shell and then reattaching the liner to the shell.

14. The method of claim 11, wherein:
the shell comprises an outer edge, and
the method further comprises passing a person's head through a head opening defined by outer edge.

15. The method of claim 14, wherein:
a groove is formed into the convex upper surface of the liner, the groove defines, at least in part, the air passage, and wherein the groove forms an exhaust vent at a forward end of the groove, and
the activating of the fan forces the cooled air through the groove and out of the exhaust vent to cool the person's face.

16. The method of claim 11, wherein the activating of the fan draws air into an air intake hole formed through a rear-facing quadrant of the shell.

17. The method of claim 11, further comprising preventing the cooled air from escaping through a forward-facing quadrant of the shell.

18. The method of claim 11, further comprising powering the fan from a battery secured to the hat, and charging the battery using a solar cell secured to the hat.

19. The method of claim 11, further comprising activating and deactivating the fan according to signals from a temperature sensor secured to the hat.

20. The method of claim 11, wherein before activating the fan, the method comprises detaching the PCM container from the hat and then reattaching the PCM container to the hat.
